(19) United States
(12) Patent Application Publication
(10) Pub. No.: US 2017/0296993 A1
(43) Pub. Date: Oct. 19, 2017

(54) MULTIPLE MODULAR SYSTEM FOR THE FORMATION OF PARTICLES IN POWDER AND MICROCAPSULE FORM FOR DIFFERENT PROCESSES

(71) Applicant: PREMEX S.A., MEDELLIN - ANTIOQUIA (CO)

(72) Inventors: OSCAR ALEJANDRO VANEGAS MONTERROSA, ENVIGADO - ANTIOQUIA (CO); EDICSON GIRON MUNOZ, ENVIGADO - ANTIOQUIA (CO); ALEJANDRO MESA GOMEZ, MEDELLIN - ANTIOQUIA (CO)

(21) Appl. No.: 15/131,668

(22) Filed: Apr. 18, 2016

(51) Int. Cl. B01J 2/04; A61J 3/02; B01J 13/00; A61J 3/07; C05G 3/00

(52) U.S. Cl. CPC B01J 2/04; C05G 3/0058; C05G 3/0017; B01J 13/00; A61J 3/07; A61J 3/02; A23V 2002/00

(57) ABSTRACT

The present invention discloses a multiple modular system for the formation of powders, characterized in that it comprises a tower (1) comprising an interchangeable head A selected from the group consisting of a disk spray unit A1; a nozzle spray unit A2; a dual fluid spray unit A3 and a high temperature spray unit A4; and wherein said tower (1) comprises an interchangeable collector installed in the lower part B of the tower selected from the group consisting of collector type 1 (B1), collector type 2 (B2), collector type 3 (B3) and collector type 4 (B4) or combinations of the same.

### FIELD OF THE INVENTION

The present invention relates to multiple modular devices or systems for the obtainment of products in powder form having desired characteristics of particle size and configuration.

### STATE OF THE ART

The formation of powders or particulate solid materials in industrial terms is important by virtue of the fact that it is a convenient and advantageous manner of presentation of, inter alia, pharmaceutical, cosmetic, veterinary and agroindustrial products. Products in powder form permit the conservation and improvement of desirable characteristics of products such as increase in the shelf life thereof, improvement in dosing, ease of storage and ease of transport thereof because, by virtue of the water content thereof, they may be susceptible to experiencing undesired chemical reactions and degradation through attack, inter alia, by microorganisms.

Apparatuses or devices for drying, encapsulation and microencapsulation of various substances were known in the state of the art wherein, according to the product in powder form to be obtained, the use of a specific apparatus, the use of several coupled units or the interchange of apparatuses to obtain the desired result is required, signifying that the processes for obtainment of powders having differing requirements of size, of composition and of disposition of active ingredients within a matrix necessitated complex infrastructure and long waiting periods between the replacement of apparatuses. For different industrial processes requiring different drying equipment, for example for independent industrial processes requiring spray cooling, fluidized bed drying or spray drying, three apparatuses were required to realize said drying stages.

In this respect, U.S. Pat. No. 300,521 is known to disclose an apparatus for obtaining detergent compositions in powder form, wherein there is disclosed an apparatus for drying solely by spraying, wherein the apparatus has multiple nozzles in the upper part and means for continuous counter current spraying, wherein the equipment has a single spraying device.

For its part, the document GB 9808470 divulges a process and an apparatus for producing finely divided powders for pharmacological substances, wherein the drying apparatus corresponds solely to an apparatus of fluidized bed type, wherein a current of compressed air is supplied to a milling chamber to obtain a finely divided material through a stage of simultaneous milling and drying.

On the other hand, the patent CN 101278688 reveals a coupling between fluidized bed drying and spray drying for a single process of drying a nutritional formula having a lactic base for children, wherein the equipment is adapted to present these two drying techniques simultaneously and one subsequent to the other to obtain the product desired. The spray and fluidized bed drying are taught as stages within that process and realized by independent apparatuses coupled to one another.

For its part, the document US 2009022965 reveals a technique of microencapsulation through interfacial polymerization, wherein an apparatus is utilized to manufacture microcapsules, wherein the apparatus has solely one drying unit of the spray drying type.

On the other hand, the document CN 101869150 divulges a process for the production of milk in powder form, wherein there is respectively realized: homogenization, sterilization, concentration, spray drying, fluidized bed drying, cooling and inspection of packaging of the product obtained. This document, as in the case of the patent CN 101278688, reveals processes of obtainment of products in powder form wherein the device is adapted for spray and fluidized bed drying by means of independent machines or apparatuses coupled in a sequential manner.

Finally, the document CN 102553276 divulges a combined drying and powder removal tower, wherein said tower comprises an adjustable valve having turbulence deflectors, a spray drying tower, a fluidized bed, a cyclone and a bag powder collector, and one compartment, and having an integrated combined structure wherein the equipment is a single system, said equipment not being useful nor versatile for the utilization of the units as independent apparatuses.

In spite of the advances achieved previously in respect of apparatuses involving combinations of drying techniques in a single system, it is clear that in the state of the art the need existed for a multiple system for the formation of microcapsules and, in general, of particulate material, wherein the equipment is produced in a modular manner permitting the interchange of heads and collectors in order to carry out different processes for obtaining different products in powder form by means of the same device. Similarly, it is evident that versatile systems or apparatuses were required to realize drying techniques involving spray drying, fluidized bed, spray cooling and other techniques, minimizing operating costs, materials costs, together with the facility of a single modular apparatus having interchangeable parts for different processes wherein the device is easily modified to be adapted between differing configurations of collector systems in the lower part thereof and by means of modification of spray systems in the upper part thereof. The different collectors and spray systems of the equipment of the invention permit a plurality of combinations in order to realize diverse processes for the obtainment of powders for different products including, inter alia but without being restricted thereto, pharmaceutical, cosmetic, agricultural, veterinary and alimentary products.

### DETAILED DESCRIPTION OF THE DRAWINGS

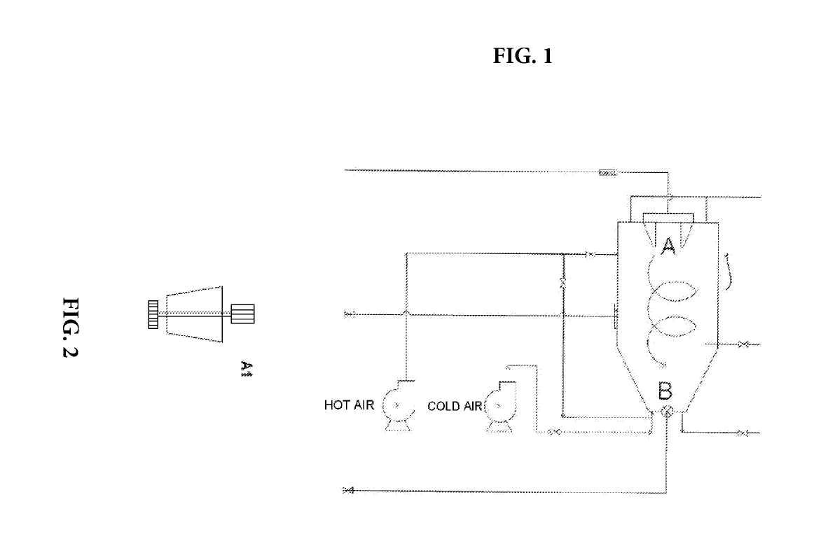

FIG. 1 shows a diagram of the system of the present invention wherein there is shown the tower (1) with the head A and the collector B.

FIG. 2 illustrates a type of disk spray head for installation in the system of the present invention in part A of FIG. 1.

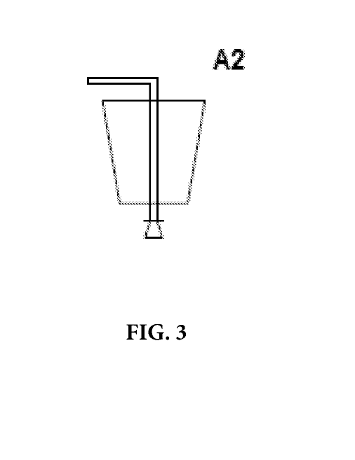

FIG. 3 illustrates a type of nozzle spray head for installation in the system of the present invention in part A of FIG. 1.

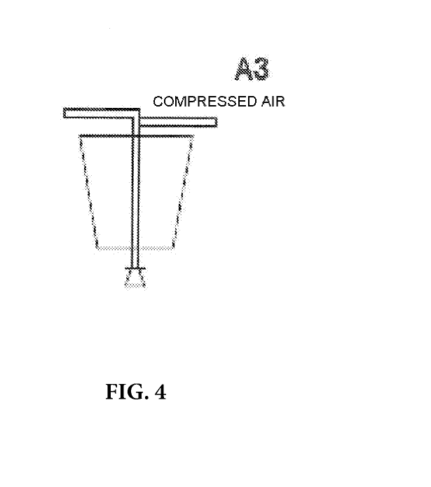

FIG. 4 illustrates a type of dual fluid spray head for installation in the system of the present invention in part A of FIG. 1.

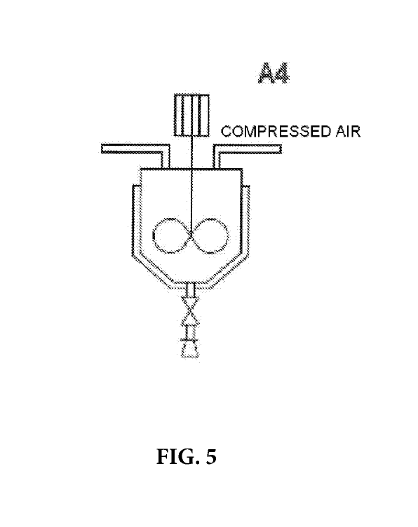

FIG. 5 illustrates a type of high-temperature spray head for installation in the system of the present invention in part A of FIG. 1.

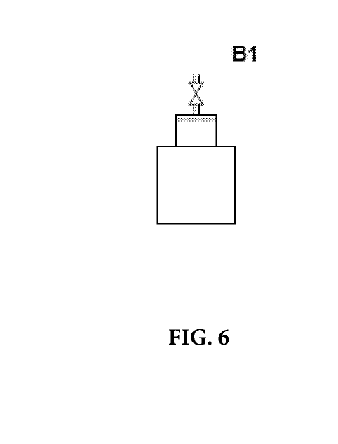

FIG. 6 illustrates a type of simple collector (type 1) for installation in the system of the present invention in part B of FIG. 1.

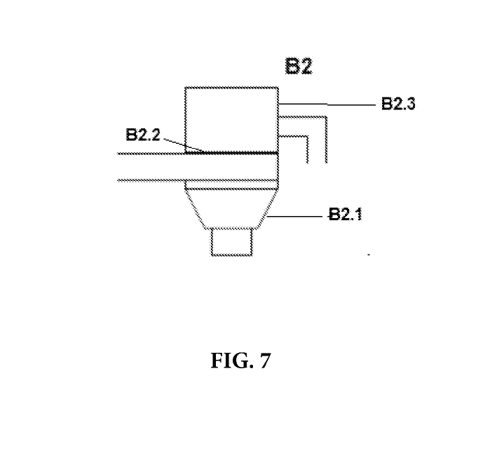

FIG. 7 illustrates a type of simple collector (type 2) for installation in the system of the present invention in part B of FIG. 1.

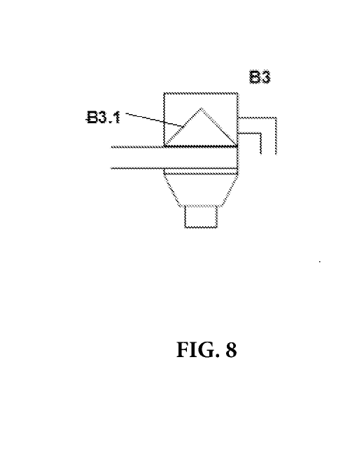

FIG. 8 illustrates a type of simple collector (type 3) for installation in the system of the present invention in part B of FIG. 1.

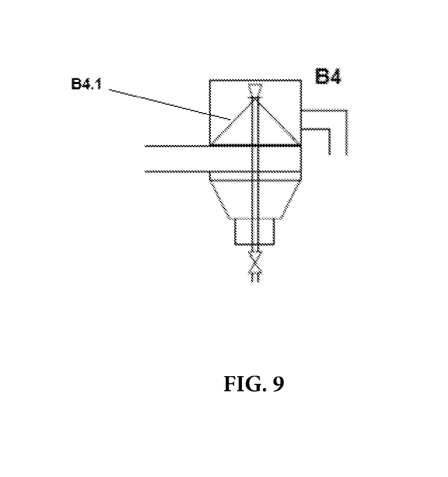

FIG. 9 illustrates a type of simple collector (type 4) for installation in the system of the present invention in part B of FIG. 1.

### DETAILED DESCRIPTION OF THE INVENTION

In one embodiment, the invention covers a multiple modular device or system useful for the obtainment of products in powder form having desired characteristics of particle size and configuration.

In another embodiment, the invention covers the use of the multiple modular device or system for the food industry, principally for the manufacture of foodstuffs in granular and/or powder form for human beings and animals, wherein the products in powder form present desired characteristics of particle size and configuration.

In another embodiment, the invention covers the use of the multiple modular device or system for the agrochemical industry, for the obtainment of minerals and fertilizers in granular and/or powder form, together with nutritional and foliar application additives.

In an additional embodiment, the invention covers the use of the multiple modular device or system for the industry related with cosmetic products.

In an additional embodiment, the invention covers the use of the multiple modular device or system for the pharmaceutical industry, principally with the preparation of solid pharmaceutical compositions wherein the products present desired characteristics of particle size and configuration.

In a further additional embodiment, the invention covers the use of the multiple modular device or system for the development of controlled release products in all the fields of application, including from active compounds in matrical form to compositions having a differentiated nucleus, it moreover being a complement to other techniques of encapsulation, wherein the products present desired characteristics of particle size and configuration.

The multiple system for the formation of particles in powder form according to the present invention is characterized by being a modular system interchanging spray heads (A) in the upper part of the apparatus for the inlet of hot air, compressed air and liquid currents, utilizing the same equipment according to the operating conditions required and, in the base of said equipment, additionally changing the collector (B) for the obtainment of the material in powder or agglomerated powder form, or of the final microencapsulated product. The design of the device of the present invention permits that the thermodynamic considerations for each specific process, together with the conditions of heat and mass transfer, be maintained.

In FIG. 1 there is shown the complete configuration of the system wherein there are illustrated the hot and cold air fans required to create the conditions in the principal tower (1).

Four heads exist for the upper part of the system, as illustrated in FIGS. 2 to 5, these being interchangeable, one being a disk spray unit A1 (FIG. 2); another being a nozzle spray unit A2 (FIG. 3); another being a dual fluid spray unit A3 (FIG. 4) and another being a high temperature spray unit A4 (FIG. 5).

The disk spray unit system A1, according to FIG. 2, consists of a high speed motor coupled to a centered shaft connected to a spray disk having rectangular outlets, wherein the high speed motor and the transmission of the shaft are cooled with compressed air, maintaining stable the expansion of the bearings.

For its part, the nozzle unit system A2, as shown in FIG. 3, is a conventional nozzle coupled to a network of pipes and containing a nozzle having a venturi effect and with reduction of diameter of the pipe to a 0.5 mm to 3 mm nozzle. Furthermore, it contains a special pressure valve which may be located on any stretch of the pipe and proximate to or distant from the nozzle.

The dual fluid nozzle system A3, as shown in FIG. 4, is a conventional nozzle for viscous non-Newtonian fluids (thixotropic and rheopectic liquids).

The high-temperature spray system or unit A4 consists of a conventional nozzle in the extremity of a pipe connected to a collector or tank having a pressurized supply and having an internal stirrer and having a pressure gauge and a compressed air inlet, wherein the complete system will be at a temperature exceeding the melting point of the material ingressing into the spray system. The required temperature of the system may be maintained by means of any conventional system of heating, for example by means of electrical resistances, thermal oil, steam jackets, or rendering the entire system adiabatic, that is to say with appropriate heat insulants, or any combination of the same.

With reference to the collectors located in part B of FIG. 1, the interchangeable collectors may be of conical type having valves and collectors. Others are of chamber type having two compartments having a tangential air inlet separated by an interchangeable collector mesh for the purposes of movement of the particles. The collector mesh may be flat and between 50 and 400 for a particle size of between 295 microns and 37 microns, respectively. In one embodiment, said mesh may be conical, as shown in the type 3 collector (B3 and B4).

The collector B1, as shown in FIG. 6, is a collector of particulate material having a double jacket to maintain the final temperature of the product and to prevent rehydration arising from the conditions of humidity external to the equipment; according to the disposition of the outlet air connections it is located solely at the outlet from the cyclone or, in defect thereof, two thereof are coupled, one in the conical section of the tower and the other in the outlet from the cyclone.

The collector B2, as shown in FIG. 7, comprises three parts, a lower body of support and finished product discharge, an intermediate mesh, interchangeable according to the type of system to be connected and the particle size to be operated, and an upper body having a tangential air inlet to increase the pressure and permit the fluidization of particles; this device permits varying the dwell time of the particles within the interior thereof, permitting achieving the desired conditions of humidity, increasing particle size by means of the spraying of agglutinant and increasing sphericity in the case of cold microencapsulated particles.

The collector B3, as shown in FIG. 8, incorporates into the collector B2 a conical support (B3.1) having an angle of inclination of 60° permitting changing the manner in which the air ascends, developing an enveloping and toroidal flow permitting the agglomeration of particles, increasing the size thereof; the reduction in the area of the mesh does not reduce the effective working area by virtue of the fact that the conical surface possesses air inlet points to take advantage of the inclined area.

Additionally, B3 presents a chamber having two compartments, one thereof having a tangential air inlet and possessing a conical accessory or support (B3.1) modifying the flow of the air and the manner in which the latter is dispersed.

The collector B4, as shown in FIG. 9, incorporates into the collector B2 a conical support (B4.1) having an angle of inclination of 45° and a variable height nozzle type spray system, permitting the injection of agglutinant and changing the particle size of the particles exposed.

In the present invention, this collector may be advantageously employed both for processes involving low temperature spraying (spray cooling) and those processes including a fluidized bed for drying and agglomeration, wherein the conditions of temperature of the air entering the system are changed.

The equipment or system of the present invention is very versatile by virtue of the fact that it permits being adapted to configurations of one or two simultaneous collectors, depending on the necessities of the process required, for example for the obtainment of particulate material having two different types of percentage humidity and for when a particulate product is required to be obtained having different particle size characteristics. The equipment of the invention presents the technical advantage of being capable of varying the dwell times of the particles by means of the modifications and/or adaptations made to the configuration of the collectors. In this sense, for the embodiment of a device of the invention having a single collector and high dwell times, a more homogeneous particulate product will be advantageously obtained, and for devices of the invention having two collectors, two homogeneous products, differing from one another however, will be obtained.

### EXAMPLES

### Example 1

### Microencapsulation of Organic Acids by Spray Cooling

In animal feeding the effect is known that organic acids have on pathogenic bacteria in the animals on reducing the pH of the intestinal medium and propitiating cellular lysis; nevertheless the presence of these acids in the stomach wherein there exist very high conditions of humidity makes them disassociate and they do not reach the host site of the microorganisms in an appropriate condition. The solution is to protect the acids from the gastric medium by means of the encapsulation thereof in a partially soluble matrix, for example with a lipid matrix comprising mixtures of hydrogenated vegetable oils such as soya, palm, maize, sunflower and mixtures thereof having defined characteristics rendering them solid at ambient temperature.

For this purpose the configuration of the equipment utilizes the system with cold air, the spray head A4 and the collector B2.

A suggested mixture, which is however not limiting, may include citric, malic, fumaric, phosphoric acids and the salts thereof and other compounds of zootechnic interest, and the fatty matrix having derivatives of stearic acid, palm stearate, glycerin, natural waxes and mixtures thereof.

### Example

A mixture such as that described composed of:

13% Citric Acid

19.22% Fumaric Acid

8.5% Malic Acid

1.4% Ascorbic Acid

5.7% Phosphoric Acid

52.2% Fatty Matrix

wherein the fatty matrix was heated and melted between 55 and 77° C. and mixed with the organic acids until complete homogeneity thereof.

The suspension was then sprayed by means of the sprayer A4 maintaining constant temperature throughout the system. Said suspension was sprayed into the chamber onto counter current air at a temperature of 12° C.

As a result, in the lower part there were obtained spherical particles having crystals of acids in the interior thereof, suspended in the bed developed in the collector B2 in order that the friction between the particles eliminated any irregularity.

They were subsequently discharged at the outlet of collector B2, there being found particles having sizes of between 800 and 1200 microns, perfectly formed. They were subjected to a solubility test in cold water and acid medium at pH 3.5, yielding 95% retention of the acids; subsequently they were submitted to a process of heating in the presence of lipase enzymes, release of 90% being obtained in the first 24 minutes of exposure.

Practically, compositions such as these may accommodate other compounds of interest capable of being dispersed, such as antibiotics, vaccinations, anti-inflammatories, etc., the objective whereof being the release thereof in the intestine.

### Example 2

### Drying of Copper Monolysinate by Fluidized Bed

Organometallic complexes are utilized as bioavailable sources of minerals, both for human beings and for animals. These complexes are generally combinations of amino acids, such as lysine, glycine, methionine, etc., with metals, such as iron, zinc, manganese, copper, etc., and are referred to by name as chelates or complexes according to the nature of the chemical bond formed.

For the use thereof in premixtures it is necessary to have a presentation in fine powder or granular form to prevent interactions with the other components of the mixture.

Having the objective of improving the stability thereof the humidity content is required to be reduced to between 2 and 10%; for this purpose the configuration is employed of head A2 and the collector B3, utilizing hot air.

### Example

For the synthesis of copper lysinate one has the following arrangement:

44% Water

44% Copper sulfate

12% Lysine.

The water was heated to 80° C., the lysine was added and then the temperature was reduced to 65° C. and the copper sulfate was added until total dissolution.

The mixture was held at the temperature of 65° C., maintaining the reaction temperature for 40 minutes.

The solution was then sprayed onto the fluidized bed system having the following process conditions:

Inlet flow 125 m³/h

Operating temperature 65° C.

Spray pressure 30 PSI

Spray rate 45 g/minute

Nozzle diameter 1.4 mm

Inlet air temperature 160° C.

Outlet air temperature 71° C.

The agglomerated product presented an acceptable performance, a particle size of between 800 and 1100 microns being obtained; the humidity content was analyzed, reporting 7%, and it presented thermal stability in the mixing tests.

### Example 3

### Obtainment of an Encapsulated Soluble Flavoring

The technique of drying by spray dryer is well known consequent upon the efficiency thereof for the generation of solid particles having a minimum impact upon the nature of the substances to be dried. The production of aromatic compounds by means of this technique implies the development of suitable drying vehicles to prevent the losses of volatile constituents.

Having the objective of improving stability thereof, the humidity content must be reduced to between 2 and 10% and the particle size must be as small as possible to ensure the greatest area of contact; for this purpose the configuration of head A1 and the collector B1 is employed, utilizing hot air.

### Example

### Apple Flavor in Powder Form

33% Liquid artificial apple flavor

20% Maltodextrin

2% Gum Arabic

1% Yucca starch

5% Protein isolated from soya

39% Water.

The water was heated to 40° C. and the ingredients in powder form were added 1 by 1 until total dissolution was achieved, then the artificial flavor was added and the mixture was subjected to homogenization at 2500 PSI over 10 minutes.

Once this emulsion had been prepared, spraying was carried out utilizing the spray disk of the head A1, under the following conditions:

Inlet temperature 190° C.

Outlet temperature 90° C.

Disk rotational frequency 310 Hz

Inlet flow 37 liters/h.

A free-flowing powder was obtained with the microencapsulated flavoring having a particle size of between 200 and 400 microns and a percentage humidity of 3%, being stable to handling and readily dispersible in cold water. A test of active compound encapsulation was carried out, yielding 92% protection.

### Example 4

### Granulation of Calcium Propionate

Calcium propionate is utilized as a preservative in many products, such as bakery, processed meat and lactic products; in the processing plants it is utilized sprayed onto surfaces having the objective of controlling molds; nevertheless the high degree of dustiness thereof becomes a limitation by virtue of the capacity thereof to irritate the respiratory tracts.

One option for this is to develop a granulated powder form to prevent particles having sizes smaller than 200 microns, for this purpose the equipment with the head A3 and the collector B4 was utilized, having the objective of maximizing the agglomeration.

### Example

### Agglomeration of Calcium Propionate

A solution of calcium propionate in water was prepared by means of the reaction between propionic acid and sodium hydroxide in a molar ratio of 1:1.

The following parameters were utilized for the drying employing the configuration planned:

Inlet temperature 250° C.

Outlet temperature 130° C.

Supply pressure 250 PSI

Spraying rate 35 liters/h

Collector B4 rate 5 liters/h.

A granular product was obtained having a particle size of between 1000 and 1300 microns and a humidity content of 4%, the process of drying and agglomeration being effective.

The examples presented allow the practicality to be deduced of the system and of the possibilities of diverse products which may be operated, whether to obtain a product as a fine powder or agglomerate or to form diverse types of capsules and microcapsules, simply through the interchange of the head or the collectors, maintaining constant the remainder of the layout of the equipment.

1. Multiple modular system for the formation of powders, wherein it comprises a tower comprising an interchangeable head A selected from the group consisting of a disk spray unit A1; a nozzle spray unit A2; a dual fluid spray unit A3 and a high temperature spray unit A4; and wherein said tower comprises an interchangeable collector installed in the lower part B of the tower selected from the group consisting of collector type 1, collector type 2, collector type 3 and collector type 4 or combinations of the same.

2. Multiple modular system according to claim 1, wherein the disk spray unit A1 consists of a high speed motor coupled to a centered shaft connected to a spray disk having rectangular outlets, wherein the high speed motor and the shaft transmission are cooled with compressed air.

3. Multiple modular system according to claim 1, wherein the nozzle unit A2 is a nozzle coupled to a network of pipes and containing a nozzle having a venturi effect and reduction of diameter from the pipe to a 0.5 mm to 3 mm nozzle and containing a special pressure valve which may be located on any stretch of the pipe, proximate to or distant from the nozzle.

4. Multiple modular system according to claim 1, wherein the nozzle unit A3 is a nozzle for viscous non-Newtonian fluids (thixotropic and rheopectic liquids).

5. Multiple modular system according to claim 1, wherein the high-temperature spray unit A4 consists of a nozzle in the extremity of a pipe connected to a collector or pressurized supply tank having an internal stirrer and having a pressure gauge and a compressed air inlet, wherein the complete system is at a temperature exceeding the melting point of the material ingressing into the spray system and the required temperature of the system is maintained by means of a system of heating selected from electrical resistances, thermal oil, steam jackets or heat insulants or a combination of the same.

6. Multiple modular system according to claim 1, wherein the interchangeable collector B1 of the tower is a collector of particulate material having a double jacket to maintain the final temperature of the product and prevent rehydration arising from the conditions of humidity external to the equipment, and located solely at the outlet from the cyclone, or two thereof are coupled into the conical section of the tower and into the outlet from the cyclone.

7. Multiple modular system according to claim 1, wherein the interchangeable collector B2 of the tower comprises three parts being: a lower body of support and discharge of finished product (B2.1), an intermediate mesh (B2.2), interchangeable according to the type of system to be connected and the particle size to be operated, and an upper body having a tangential air inlet (B2.3) increasing the pressure and permitting the fluidization of particles; this device permits varying the dwell time of particles in the interior thereof, permitting achieving the desired conditions of humidity, increasing particle size by means of the spraying of agglutinant and increasing particle sphericity in the case of cold microencapsulation.

8. Multiple modular system according to claim 1, wherein the interchangeable collector B3 of the tower incorporates into the collector B2 a conical support (B3.1) having an angle of inclination of 60° permitting changing the manner in which the air ascends developing an enveloping and toroidal flow permitting the agglomeration of particles, increasing the size thereof, and wherein the conical surface possesses air inlet points to take advantage of the inclined area.

9. Multiple modular system according to claim 1, wherein the interchangeable collector B4 of the tower incorporates into the collector B2 a conical support (B4.1) having an angle of inclination of 45° and a variable height nozzle type spray system permitting the injection of agglutinant and the change in the particle size of the particles exposed.

10. Multiple modular system according to claim 6, wherein the interchangeable collectors B2 and B3 present a collector mesh having a mesh size of between 50 and 400.

11. Multiple modular system according to claim 7, wherein the interchangeable collector B3 presents a chamber having two compartments, one thereof having tangential air inlet and possessing a conical accessory to modify the flow of the air and the manner in which the latter is dispersed.

12. Use of the multiple modular system according to claim 1, for the obtainment of products in powder form.

13. Use of the multiple modular system according to claim 1, for the industry of food in granular and/or powder form for human beings and animals.

14. Use of the multiple modular system according to claim 1, for the industry related with cosmetic products.

15. Use of the multiple modular system according to claim 1, for the pharmaceutical industry.

16. Use of the multiple modular system according to claim 1, for the agrochemical and foliar fertilization industry.

17. Use of the multiple modular system according to claim 1 for the production of controlled release products, from active compounds in matrical form to compositions having differentiated nucleus, it being moreover a complement to other encapsulation techniques, wherein the products present desired characteristics of particle size and configuration.
